(19) United States
(12) Patent Application Publication
(10) Pub. No.: US 2022/0159587 A1
(43) Pub. Date: May 19, 2022

(54) USER EQUIPMENT ORIENTED LINK ADAPTATION

(71) Applicant: Nokia Technologies Oy, Espoo (FI)

(72) Inventors: Kyoungmin Park, Suji gu (KR); Hans Höhne, Helsinki (FI); Timo Lunttila, Espoo (FI); Klaus Hugl, Vienna (AT)

(21) Appl. No.: 17/441,226

(22) PCT Filed: Mar. 6, 2020
(86) PCT No.: PCT/FI2020/050144

§ 371 Date: Sep. 20, 2021

Related U.S. Application Data
(60) Provisional application No. 62/824,166, filed on Mar. 26, 2019.

(51) Int. Cl. H04W 52/36; H04L 1/00; H04W 52/24; H04W 52/26

(52) U.S. Cl. CPC H04W 52/367; H04L 1/0003; H04W 52/262; H04W 52/242; H04W 52/243; H04L 1/0009

(57) ABSTRACT

Systems, methods, apparatuses, and computer program products for optimizing user equipment (UE) oriented link adaptation. One method may include receiving a configuration of a predefined transmission power for one or more cases. The method may also include calculating a required transmission power based on at least a specific pathloss of the one or more cases. In addition, the method may include, selecting, based on the calculation of the required transmission power, a modulation coding scheme level that does not exceed the predefined transmission power for a radio transmission. Further, the method may include performing the radio transmission based on the selected modulation coding scheme level and the calculated required transmission power.

### CROSS-REFERENCE TO RELATED APPLICATIONS

This application claims priority from U.S. provisional patent application No. 62/824,166 filed on Mar. 26, 2019. The contents of this earlier filed application are hereby incorporated by reference in their entirety.

### FIELD

Some example embodiments may generally relate to mobile or wireless telecommunication systems, such as Long Term Evolution (LTE) or fifth generation (5G) radio access technology such as new radio (NR), or other communications systems. For example, certain embodiments may relate to systems and/or methods for optimizing user equipment (UE) oriented link adaptation.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. 5G is mostly built on a new radio (NR), but a 5G (or NG) network can also build on E-UTRA radio. It is estimated that NR provides bitrates on the order of 10-20 Gbit/s or higher, and can support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) may be named gNB when built on NR radio and may be named NG-eNB when built on E-UTRA radio.

### SUMMARY

One embodiment may be directed to a method. The method may include receiving a configuration of a predefined transmission power for one or more cases. The method may also include calculating a required transmission power based on at least a specific pathloss of the one or more cases. The method may further include selecting, based on the calculation of the required transmission power, a modulation coding scheme level that does not exceed the predefined transmission power for a radio transmission. Further, the method may include performing the radio transmission based on the selected modulation coding scheme level and the calculated required transmission power.

Another example embodiment may be directed to an apparatus. The apparatus may include means for receiving a configuration of a predefined transmission power for one or more cases. The apparatus may also include means for calculating a required transmission power based on at least a specific pathloss of the one or more cases. The apparatus may further include means for selecting, based on the calculation of the required transmission power, a modulation coding scheme level that does not exceed the predefined transmission power for a radio transmission. Further, the apparatus may include means for performing the radio transmission based on the selected modulation coding scheme level and the calculated required transmission power.

Another example embodiment may be directed to an apparatus which may include at least one processor and at least one memory including computer program code. The at least one memory and the computer program code may be configured to, with the at least one processor, cause the apparatus at least to receive a configuration of a predefined transmission power for one or more cases. The apparatus may also be caused to calculate a required transmission power based on at least a specific pathloss of the one or more cases. The apparatus may further be caused to select, based on the calculation of the required transmission power, a modulation coding scheme level that does not exceed the predefined transmission power for a radio transmission. Further, the apparatus may be caused to perform the radio transmission based on the selected modulation coding scheme level and the calculated required transmission power.

In accordance with some example embodiments, a non-transitory computer readable medium may be encoded with instructions that may, when executed in hardware, perform a method. The method may include receiving a configuration of a predefined transmission power for one or more cases. The method may also include calculating a required transmission power based on at least a specific pathloss of the one or more cases. The method may further include, selecting, based on the calculation of the required transmission power, a modulation coding scheme level that does not exceed the predefined transmission power for a radio transmission. Further, the method may include performing the radio transmission based on the selected modulation coding scheme level and the calculated required transmission power.

In accordance with some example embodiments, a computer program product may perform a method. The method may include receiving a configuration of a predefined transmission power for one or more cases. The method may also include calculating a required transmission power based on at least a specific pathloss of the one or more cases. The method may further include, selecting, based on the calculation of the required transmission power, a modulation coding scheme level that does not exceed the predefined transmission power for a radio transmission. Further, the method may include performing the radio transmission based on the selected modulation coding scheme level and the calculated required transmission power.

In accordance with some example embodiments, an apparatus may include circuitry configured to receive a configuration of a predefined transmission power for one or more cases. The apparatus may also include circuitry configured to calculate a required transmission power based on at least a specific pathloss of the one or more cases. The apparatus may further include circuitry configured to select, based on the calculation of the required transmission power, a modulation coding scheme level that does not exceed the predefined transmission power for a radio transmission. Further, the apparatus may include circuitry configured to perform the radio transmission based on the selected modulation coding scheme level and the calculated required transmission power.

In accordance with some example embodiments, a method may include determining, based on received measurements of a communication network, which case out of a plurality of cases more interference would be detected. The method may also include predicting, based on the determination, which case a mobile terminal needs to increase or reduce transmission power or perform a full power transmission. The method may further include configuring the mobile terminal with a predefined transmission power for one or more cases. In addition, the method may include configuring, based on the configuration of the mobile terminal, a set of modulation coding schemes from which the mobile terminal selects a modulation coding scheme for a radio transmission.

In accordance with some example embodiments, an apparatus may include means for determining, based on received measurements of a communication network, which case out of a plurality of cases more interference would be detected. The apparatus may also include means for predicting, based on the determination, which case a mobile terminal needs to increase or reduce transmission power or perform a full power transmission. The apparatus may further include means for configuring the mobile terminal with a predefined transmission power for one or more cases. In addition, the apparatus may include means for configuring, based on the configuration of the mobile terminal, a set of modulation coding schemes from which the mobile terminal selects a modulation coding scheme for a radio transmission.

In accordance with some example embodiments, an apparatus may include at least one processor and at least one memory including computer program code. The at least one memory and the computer program code may be configured to, with the at least one processor, cause the apparatus at least to determine, based on received measurements of a communication network, which case out of a plurality of cases more interference would be detected. The apparatus may also be caused to predict, based on the determination, which case a mobile terminal needs to increase or reduce transmission power or perform a full power transmission. The apparatus may also be caused to configure the mobile terminal with a predefined transmission power for one or more cases. In addition, the apparatus may be caused to configure, based on the configuration of the mobile terminal, a set of modulation coding schemes from which the mobile terminal selects a modulation coding scheme for a radio transmission.

In accordance with some example embodiments, a non-transitory computer readable medium can be encoded with instructions that may, when executed in hardware, perform a method. The method may include determining, based on received measurements of a communication network, which case out of a plurality of cases more interference would be detected. The method may also include predicting, based on the determination, which case a mobile terminal needs to increase or reduce transmission power or perform a full power transmission. The method may further include configuring the mobile terminal with a predefined transmission power for one or more cases. In addition, the method may include configuring, based on the configuration of the mobile terminal, a set of modulation coding schemes from which the mobile terminal selects a modulation coding scheme for a radio transmission.

In accordance with some example embodiments, a computer program product may perform a method. The method may include determining, based on received measurements of a communication network, which case out of a plurality of cases more interference would be detected. The method may also include predicting, based on the determination, which case a mobile terminal needs to increase or reduce transmission power or perform a full power transmission. The method may further include configuring the mobile terminal with a predefined transmission power for one or more cases. In addition, the method may include configuring, based on the configuration of the mobile terminal, a set of modulation coding schemes from which the mobile terminal selects a modulation coding scheme for a radio transmission.

In accordance with some embodiments, an apparatus may include circuitry configured to determine, based on received measurements of a communication network, which case out of a plurality of cases more interference would be detected. The apparatus may also include circuitry configured to predict, based on the determination, which case a mobile terminal needs to increase or reduce transmission power or perform a full power transmission. The apparatus may further include circuitry configured to configure the mobile terminal with a predefined transmission power for one or more cases. In addition, the apparatus may include circuitry configured to configure, based on the configuration of the mobile terminal, a set of modulation coding schemes from which the mobile terminal selects a modulation coding scheme for a radio transmission.

### BRIEF DESCRIPTION OF THE DRAWINGS

For proper understanding of example embodiments, reference should be made to the accompanying drawings, wherein:

FIG. 1 illustrates a user equipment (UE) specific multiple maximum power (P_max) and UE oriented modulation and coding scheme (MCS) selection, according to an example embodiment, according to an example embodiment.

FIG. 2 illustrates a table with different resource sets (“cases”) or conditions/settings for MCS levels 0, 1, and 2, according to an example embodiment.

FIG. 3 illustrates an application to non-orthogonal multiple access (NOMA) uplink (UL) transmission, according to an example embodiment.

FIG. 4 illustrates a new radio-unlicensed (NR-U) subband selection scheme, according to an example embodiment.

FIG. 5 illustrates a new radio-unlicensed (NR-U) subband selection in a UE operation, according to an example embodiment.

FIG. 6 illustrates a service type specific power control and MCS level selection scheme, according to an example embodiment.

FIG. 7 illustrates different block error rate (BLER) configurations per case, according to an example embodiment.

FIG. 8 illustrates case specific BLER configurations and corresponding power control (PC) settings for MCS selection, according to an example embodiment.

FIG. 9 illustrates a flow diagram of a method, according to an example embodiment.

FIG. 10 illustrates a flow diagram of another method, according to an example embodiment.

FIG. 11(a) illustrates a block diagram of an apparatus, according to an example embodiment.

FIG. 11(b) illustrates a block diagram of another apparatus, according to an example embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for optimizing user equipment (UE) oriented link adaptation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

Semi-statically or semi-persistently scheduled uplink (UL) data (physical uplink shared channel (PUSCH)) transmission is supported for NR in Rel-15 with the name of “configured grant transmission,” and the detailed usage and further optimization for NR Rel-16 have been discussed within 3GPP Rel-16 non-orthogonal multiple access (NOMA) study item and 3GPP Rel-16 ultra-reliable low-latency communications (URLLC) study item. For example, the NOMA study item focused on the evaluation of various NOMA schemes, mostly focusing on MTC service with configured grant transmission, and discussions on MTC service seems to be open in Rel-17 again where the necessity of enhanced non-scheduled transmission is expected. Link adaptation with/without downlink control information (DCI) is one of the items of interest.

From radio access network 1 (RAND, UL data transmission and detection procedures of Rel-15 configured grant may serve as a starting point for NOMA study. In addition, different UL data transmission and detection procedures from Rel-15 configured grant for NOMA study may be considered along with how to handle UE oriented link adaptation. For example, the different UL data transmission and detection procedures may include the preamble, demodulation reference signal (DMRS), synchronization, resource (physical resource and multiple access (MA) signature) configuration, UE detection, hybrid automatic repeat request (HARQ) retransmission and acknowledgement/negative acknowledgement (ACK/NACK) feedback, link adaption, adaptation between orthogonal and non-orthogonal multiple access, collision control, etc. It is expected that the enhancement of MTC service can be discussed in 3GPP, and the similar approaches discussed in NOMA to support MTC could be considered again.

NR Rel-16 strives for further enhancement of cellular communication in unlicensed bands, and there is a need for this usage to include dynamic bandwidth adaptation in UL (depending on the outcome of listen-before-talk (LBT) procedures or channel clear assessment (CCA) procedures) with/without gNB's dedicated management. Thus, UE oriented link adaptation in UL may be useful for either licensed band communication or unlicensed band communication.

There is a lack of information at the UE regarding the effective UL signal to interference plus noise ratio (SINR) experienced at the gNB receiver, which complicates UL link adaptation at the UE side. Since a UE cannot have a full understanding on the interference that the gNB receiver observes, the gNB is in a better position for controlling the UE's modulation and coding scheme (MCS) selection for PUSCH. Thus, certain example embodiments may provide a scheme for gNB controlled UE's MCS/transmission power selection, which allows for reliable and efficient (low interference) operation.

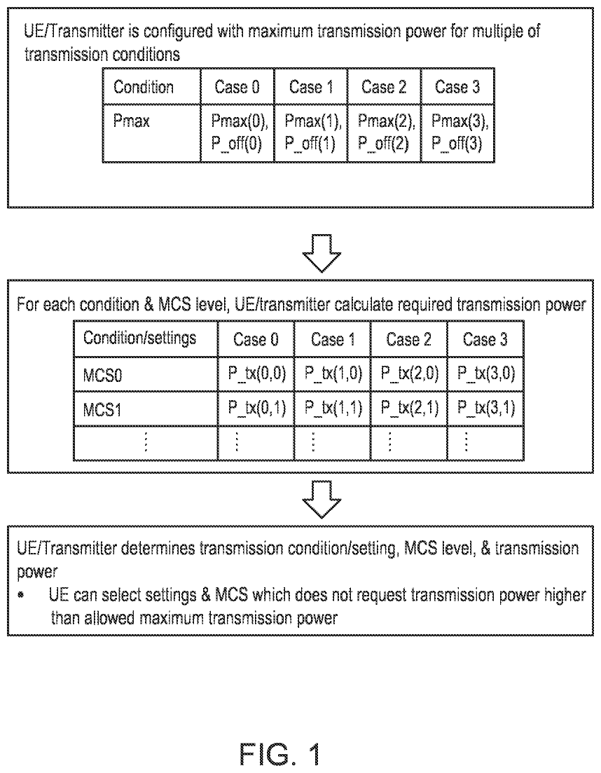

Certain example embodiments may provide a UE oriented link adaptation (MCS level selection) where the interference level may be managed by the gNB. For instance, in an example embodiment, the gNB may configure a maximum transmission power per UE and per resource set. As will be discussed in more detail herein, the resource set may correspond to “cases” as illustrated in FIG. 1. Each resource set/case may correspond, for example, to a specific carrier, subband, cell, transmission reception point (TRP), set of physical resource blocks (PRBs), NOMA spreading code, target block error rate (BLER), or any combination thereof.

For example, in an example embodiment, the gNB may configure a small value of maximum transmission power on a subband expected with heavy interference from nearby cells to avoid generation of additional interference. According to an example embodiment, the maximum transmission power that the UE supports may 23 dBm, or less. Further, a small value of the maximum transmission power may be, for example, 10 dBm or less. In another example, the gNB may configure a large value of maximum transmission power on a specific set of NOMA subbands, if less frequent usage is expected for that set. According to an example embodiment, the large value of maximum transmission power may be 23 dBm or a maximum transmission power that the UE can support.

According to an example embodiment, at an UL transmission occasion, the UE may calculate the required transmission power for various MCS levels. The UE may also select an MCS level which does not exceed an allowed maximum transmission power in the selected resource set. For instance, in one example embodiment, the UE may select the highest possible MCS level, which allows for maximizing the size of the data packets. In a case of not having sufficient data to transmit, the UE may choose a smaller MCS level in order to reduce its transmission power (produced interference) if possible.

FIG. 1 illustrates a UE specific multiple maximum power (Pmax) and UE oriented MCS selection, according to an example embodiment. For instance, as illustrated in FIG. 1, the UE/transmitter may be configured with a maximum transmission power for multiple transmission conditions. The conditions may include, for example, cases 0 to 3. Once the UE/transmitter is configured, the UE/transmitter may calculate, for each condition and MCS level, a required transmission power (P_tx). With the required transmission power, the UE/transmitter may then determine a transmission condition/setting, MCS level, and transmission power. The UE may also select settings and MCS which does not request transmission power higher than allowed maximum transmission power.

According to an example embodiment, a UE operation may be provided. For example, in an embodiment, the UE may receive, from the gNB, the configuration of maximum transmission power (Pmax) for one or more cases. The type of signaling for providing the max transmission power may include radio resource control (RRC)-signaling, which may, in one embodiment, be UE specific. In a further example embodiment, each case may correspond to a configuration of UL transmission where separate values/settings may be included for one or a combination of the following: different PRBs on a carrier; different carriers (or subbands in NR-U case); different targeted TRPs or panels at the UE side for transmission; different target BLER; different criteria of MCS level to tx power relation (e.g., Δ_{TF,b,f,c}(i)); different quality of service classes, or traffic priority classes; and different configured grant transmission configurations.

In an example embodiment, the UE may also be configured with a set of MCS from which the UE may select an MCS for UL transmission. For instance, in an example embodiment, the UE may be configured with the set of MCS via RRC-signaling. In addition, for each case X and MCS Y of the set, the UE may calculate the required transmission power P_tx (case_idx, MCS_level) based on at least case specific pathloss, P0.

According to an example embodiment, a possible way for the UE to calculate the required transmission power P_tx is by calculating the required Tx power based on the Rel-15 NR power control equation shown below:

$${P}_{PUSCH , b , f , c} ( i , j , {q}_{d} , l ) = min \{ \begin{matrix}{P}_{CMAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

Where P₀_{_{PUSCH,b,f,c}}(j) is the power offset for beam index j, 2^{μ}·M_{RB,b,f,c}^{PUSCH} is transmission bandwith of PUSCH calculated as a # of PRBs in 15 KHz numerology, α_{b,f,c}(j) is the weight factor of proportional pathloss compensation, PL_{b,f,c}(q_{d}) is a pathloss measured on the reference signal indexed by q_{d}, Δ_{TF,b,f,c}(i) is the power offset according to the MCS level, and f_{b,f,c}(i, l) is closed loop power control order with 1 indicating which order to be applied on the PUSCH transmission. In all the notation, ‘i’ means i^{th} transmission occasion of PUSCH, b indicates bandwith part, f indicates carrier, and c indicates serving cell where PUSCH transmission is configured.

A seen in the above equation, the required Tx power (P_{PUSCH}) may be calculated from power offset (P_{0_PUSCH}, which is denoted as P_off in FIG. 1), which may be case specific. The required Tx power may also be calculated from MCS level specific value (Δ), bandwidth specific parameter (M^{PUSCH}), pathloss (PL), and gNB's power control order (f).

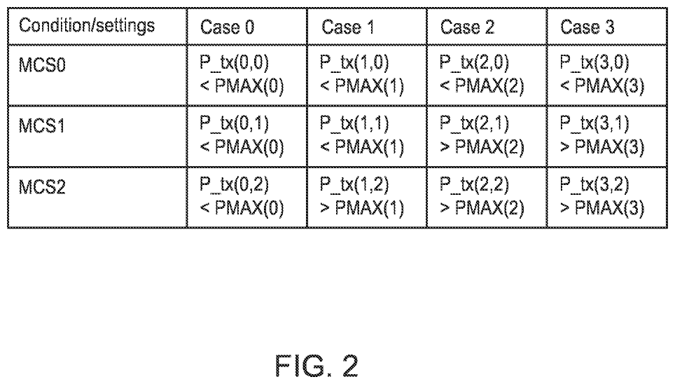

FIG. 2 illustrates a table with different resource sets (“cases”) or conditions/settings for MCS levels 0, 1, and 2. As illustrated in FIG. 2, the UE may select any MCS level which does not exceed a case specific maximum transmission power. For example, with the equation and example of FIG. 1 above, if the UE found the relation between required Tx power and maximum allowed power as illustrated in FIG. 2, then the UE may select case 0 with MCS level 0˜2, case 1 with MCS level 0˜1, case 2 with MCS level 0, or case 3 with MCS level 0. If, however, high spectral efficiency is preferred, the UE may select case 0 and MCS level 2, since only case 0 can support the highest MCS level, level 2.

As another example, if the UE is configured to use case 1, the UE may select MCS level 0 or level 1. In another example embodiment, if lower Tx power is preferred, the UE may select MCS level 0. However, if high spectral efficiency is preferred, the UE may select MCS level 1.

According to another example embodiment, the UE may transmit with the selected MCS level and the calculated transmission power. In addition, the “case” based on which the MCS is determined may be determined by the UE based on the resource configuration (configured grant parameters, including, for example, time/frequency domain resources). Alternatively, in another example embodiment, the “case” based on which the MCS is determined may be indicated explicitly to the UE as part of the downlink control signaling used for activating the configured grant transmission.

An example embodiment for NOMA UL transmission may be provided. For instance, when multiple UEs with NOMA signature are received simultaneously, the gNB may perform successive interference cancellation (SIC) to demodulate data. Further, when there is a power difference of the received signals of several UEs, it may be easier to perform SIC. In another example embodiment, suggestions of UE or NOMA signature grouping may be provided where different transmission power may be allowed for each group. The MA signature group may not indicate any specific way of grouping.

According to other example embodiments, maximum transmission power may be configured for groups of UEs or groups of MA signatures. When the UE selects an MA signature, where the details on selection rule depends on interference management algorithm, the UE may consider the maximum allowed transmission power together with the required MCS level to efficiently transmit UL data. In an example embodiment, the UE may either randomly select the MA signature or be configured with an MA signature by the gNB. As a further modification, different power offset (P0, or power boosting for UL transmission) may be configured for groups of UEs or MA signatures.

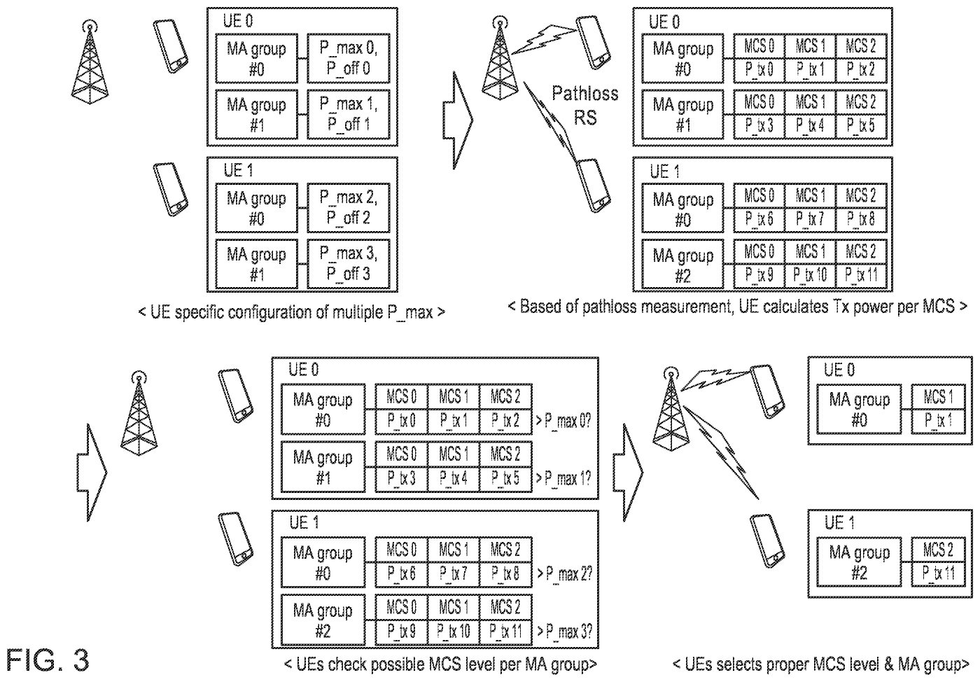

FIG. 3 illustrates an application to NOMA UL transmission, according to an example embodiment. As illustrated in FIG. 3, the UE may be a UE-specifically configured by the gNB with P_max per MA signature group. The configuration may, for example, be by way of a signal via RRC. In addition, multiple UE specific P_offset (P0) may be configured together.

As further illustrated in FIG. 3, based on the pathloss measured by the UE and according to the UL power control equation, the UE may calculate the expected transmission power per MCS level and MA group. For example, in an embodiment, the UE may measure pathloss from a downlink reference signal configured for pathloss measurement, and calculate the required transmission power from the power control equation shown above. If multiple of P_offset(P0) are configured as P_offset per MA group, then a different transmission power may be required per MA group.

FIG. 3 also illustrates that the UE may determine the possible combinations of MA groups and MCS levels by comparing required transmission power and allowed maximum transmission power. In an example embodiment, the combinations which require less transmission power than the configured maximum allowed transmission power—bold in the figure—may be the possible combination (per MA group). Then, FIG. 3 illustrates that among the possible combinations, the UE may select the most proper combination of MA group and MCS level. In doing so, the UE may select the combination with maximum MCS level (maximum spectral efficiency) to be able to transmit as much data as possible. However, if the UE does not have enough data to transmit, the UE may select a combination with a smaller MCS level to reduce its transmission power and related produced UL interference.

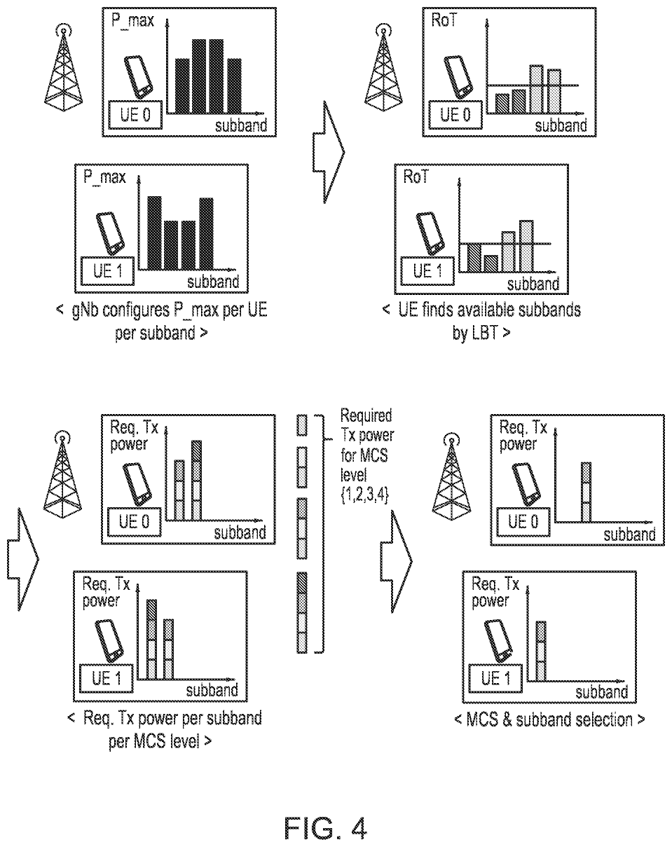

FIG. 4 illustrates a new radio-unlicensed (NR-U) subband selection scheme, according to an example embodiment. In this type of selection scheme, the UE may perform LBT/CCA to check available subbands before the transmission. Since the availability of each subband may be determined by the observed interference level (using, for example, energy detection), interference management may be a very important scheme for unlicensed band communication. On the other hand, more control information sent from the gNB to the UE may cause additional interference detected by LBT. Thus, a UE oriented MCS selection with gNB oriented interference management may provide a good solution to improve overall performance of unlicensed band communication.

According to an example embodiment, based on long-term measurements performed by the gNB or UE, such as RSSI (Received Signal Strength Indicator), or with other means, the gNB may obtain information on which subband more interference would be detected. According to an example embodiment, the gNB may obtain information on which subband more interference would be detected for example, based on long-term UL interference measurements. In a further example embodiment, based on that observation and other UE specific information, the gNB may predict on which subband each UE needs to increase or reduce transmission power (less than the peak power) or can perform full power transmission. Based on the prediction, the gNB may configure, for example, Pmax or P_off for the UE for one or more cases. This may be accomplished based on the gNB's own measurements, or based on the measurements reported by UEs. Moreover, the gNB may obtain an overview of the interference situation on different subbands. For instance, on subbands with larger interference levels, full (or close to full) power transmission may be required to overcome the interference, while on empty (low-interference carriers), less transmit power may suffice.

As illustrated in in FIG. 4, the gNB may configure maximum transmission power for a UE per subband. For example, the gNB may configure largest transmit power levels for different subbands for UE 0 and UE 1. In an example embodiment, the configuration may be performed via RRC signaling. As further illustrated in FIG. 4, based on LBT, the UE may detect available subbands for UL transmission. In addition, the RoT illustrated in FIG. 4 represents a rise-over-thermal (noise), which may be for example, the UE determining the ratio between the total interference received on a base station and the thermal noise.

The UE may also calculate, by the above power control equation, the required transmission power per subband and per MCS level. Additionally, FIG. 4 illustrates that the UE may select the subband and MCS level from transmission by considering the required transmission power and possible MCS level per subband. In doing so, the UE may select the subband and MCS level which would maximize the MCS level, and the UE may select the subband which can support the required MCS level with the least transmission power.

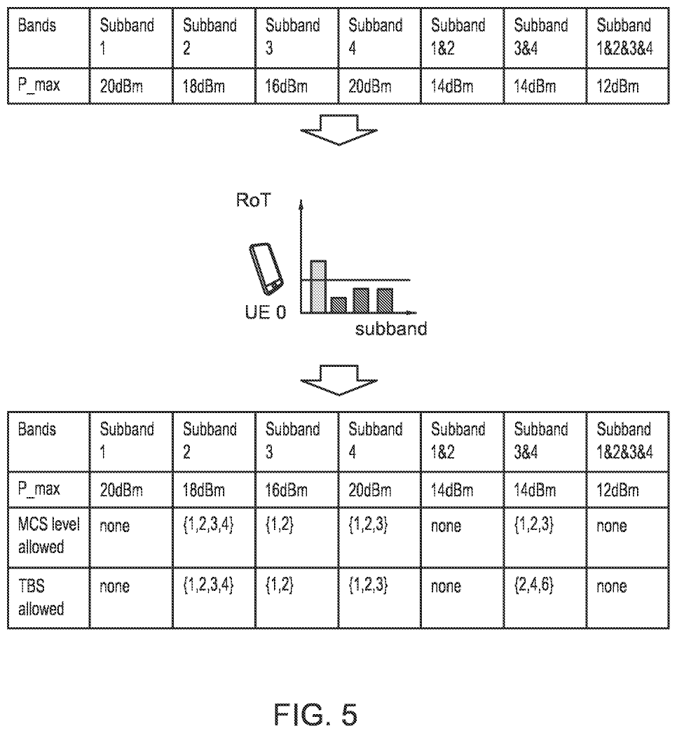

FIG. 5 illustrates a new radio-unlicensed (NR-U) subband selection in a UE operation, according to an example embodiment. As illustrated in FIGS. 4 and 5, the UE may be configured with the maximum transmission power per subband or per a combination of subbands. In this case, the possible MCS levels may be calculated per combination of subbands or per single subband. After LBT/CCA and calculating the required transmission powers for the possible MCS level per combination of subbands, the UE may select the MCS level and the combination of subbands for transmission. If the UE needs a high data rate (or has sufficient data in the buffer), the band combination with the largest applicable MCS/transport block size (TBS) may be selected.

According to another example embodiment, the maximum transmission power may be configured per subband while the UE may select multiple subbands per transport block (TB) transmission. For example, assuming that multiple subbands are configured for a UE at the same time instances, the UE may freely select the subband(s) that results in the most beneficial outcome from its own point of view. In this regard, the UE may select the subbands that allow for the highest instantaneous data rates (i.e., MCSs and transport block sizes). Further, in this case, the maximum transmission power of subband combination may be given as the smallest value of maximum transmission power configured for the subbands within the combination. With this approach, the UE may understand the maximum transmission power for all possible combinations of subbands, and extract possible MCS level and TBS for each of the subband combinations.

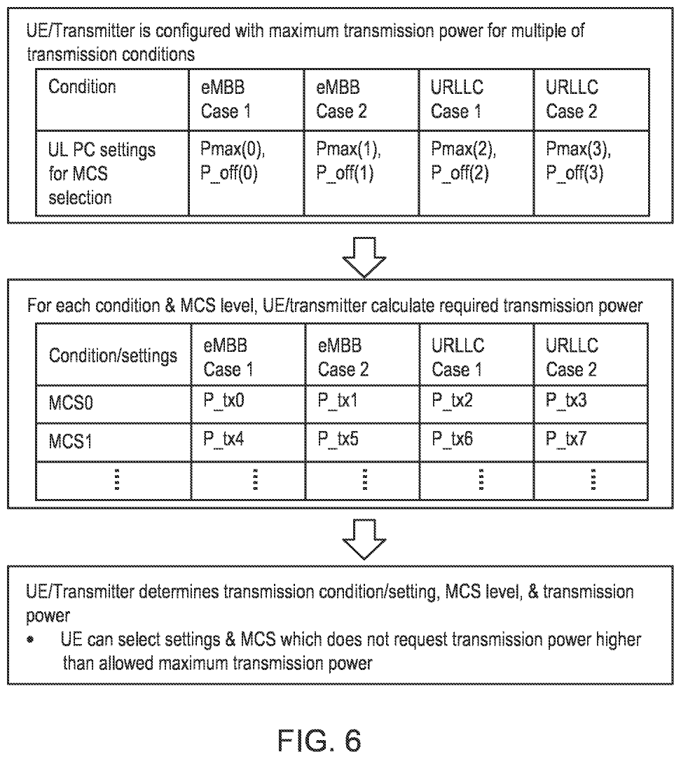

FIG. 6 illustrates a service type specific power control and MCS level selection scheme, according to an example embodiment. As illustrated in FIG. 6, in NR URLLC, service type specific power control may be enabled by for example, having the power offset of PUSCH for URLLC service and eMBB service configured differently. Since the required reliability of URLLC or eMBB may be different, such operation would be beneficial. If such a scheme is applied with such service type specific power control, then the service type specific selection of the MCS level may be supported as illustrated in FIG. 6.

For example, as illustrated in FIG. 6, the UE/transmitter may be configured with a maximum transmission power for multiple transmission conditions (e.g., “cases”). In addition, for each condition and MCS level, the UE/transmitter may calculate the required transmission power. The UE/transmitter may then determine a transmission condition/setting, MCS level, and transmission power. In doing so, the UE may select the settings and MCS which does not request transmission power higher than the allowed maximum transmission power.

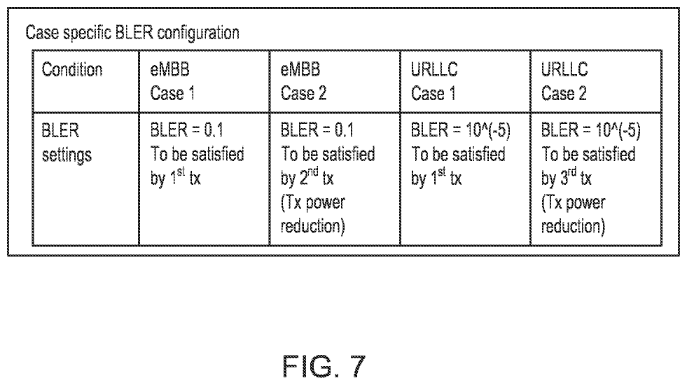

FIG. 7 illustrates different block error rate (BLER) configurations per case, according to an example embodiment. As illustrated in FIG. 7, since eMBB and URLLC need different levels of reliability, different values for target BLER may be configured for cases configured for eMBB or URLLC. In this example, a case specific BLER for the same service type is considered where the target BLER may be configured to be satisfied with different combinations of gain provided by autonomous transmission. For example, URLLC case 1 means target BLER is aimed by the 1^{st} transmission without combination gain, while URLLC case 2 means target BLER is aimed by the 3^{rd} transmission with combining gain. With such operation, the UE may have a choice between resource efficient transmission and low peak-to-average power ratio (PAPR)/power transmission. FIG. 7 illustrates such case specific BLER configuration where tx power reduction may be configured.

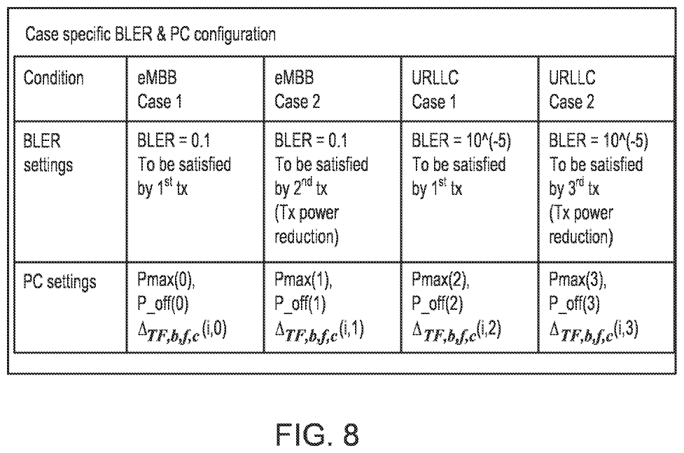

FIG. 8 illustrates case specific BLER configurations and corresponding power control (PC) settings for MCS selection, according to an example embodiment. As illustrated in FIG. 8, to be aligned with case specific BLER configurations, criteria for MCS selection may be separately configured for each case. FIG. 8 also illustrates an example where the case specific MCS selection criteria is supported by the case specific configuration of Δ_{TF,b,f,c}(i), where reuse of Rel-15 power control equation is assumed.

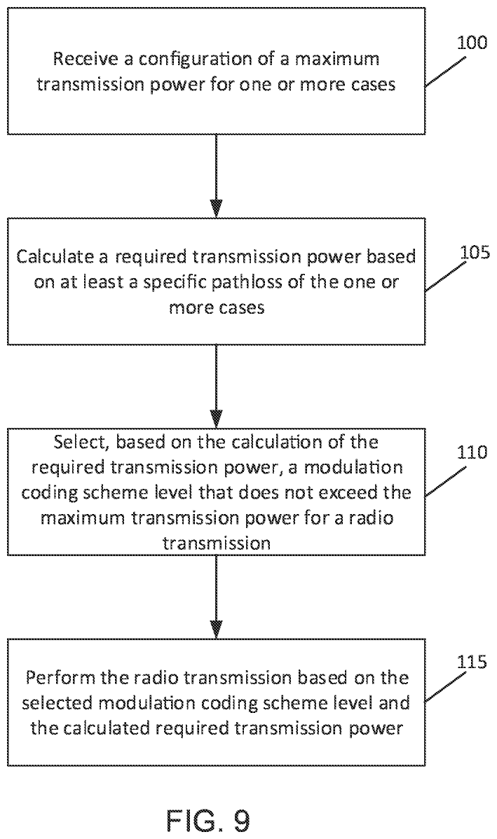

FIG. 9 illustrates a flow diagram of a method according to an example embodiment. In certain example embodiments, the flow diagram of FIG. 9 may be performed by a mobile station and/or UE, for instance. According to one example embodiment, the method of FIG. 9 may include, at 100, receiving a configuration of a predefined transmission power for one or more cases. The method may also include, at 105, calculating a required transmission power based on at least a specific pathloss of the one or more cases. In an example embodiment, the calculation may be performed for each case and modulation coding scheme level. The method may further include, at 110, selecting, based on the calculation of the required transmission power, a modulation coding scheme level that does not exceed the predefined transmission power for a radio transmission. At 115, the method may include performing the radio transmission based on the selected modulation coding scheme level and the calculated required transmission power.

In an example embodiment, the predefined transmission power may be a maximum predefined transmission power. In another example embodiment, the selected modulation coding scheme level may be the highest possible modulation coding scheme level that the calculated transmission power allows for. In another example embodiment, the one or more cases may correspond to a configuration of UL transmission where separate settings are included for at least one of different physical resource blocks on a carrier, different carriers, different bandwidth parts, different targeted transmission reception points or panels at a mobile terminal side for transmission, different target block error rate, different criteria of modulation coding scheme levels to transmission power relation, different quality of service classes or traffic priority classes, or different configured grant transmission configurations or resources.

According to an example embodiment, the selection of the modulation coding scheme level may be dependent on a preference of transmission power or spectral efficiency. In another example embodiment, the case may be determined by a mobile terminal based on a resource configuration or the case is indicated explicitly to the mobile terminal as a part of a downlink control signaling. The case, in an example embodiment, may correspond to a resource set, which may in turn correspond to, for example, a specific carrier, subband, cell, TRP, set of PRBs, NOMA spreading code, target BLER, or any combination thereof.

In a further example embodiment, the configuration of the predefined transmission power may be for a group, and the group may include a plurality of mobile terminals and a plurality multiple access signatures for NOMA operation. According to another example embodiment, calculating the required transmission power may further be based on a service type specific radio operation. For example, the service type may include PUSCH for URLLC service or eMBB service. Further, the power offset of PUSCH for URLLC service or eMBB service may be configured differently.

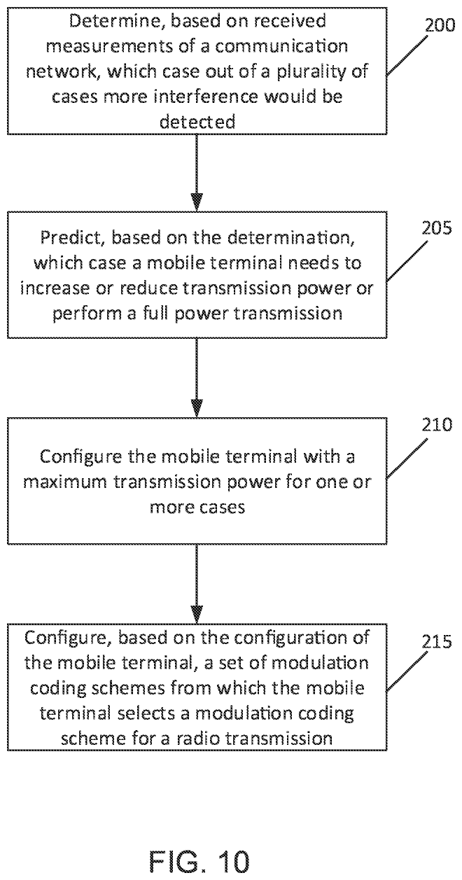

FIG. 10 illustrates a flow diagram of another method, according to an example embodiment. In certain example embodiments, the flow diagram of FIG. 10 may be performed by a network entity or network node in a 3GPP system, such as LTE or 5G NR. For instance, in some example embodiments, the method of FIG. 10 may be performed by a base station, eNB, or gNB.

According to one example embodiment, the method of FIG. 10 may include, at 200, determining, which case out of a plurality of cases more interference would be detected. In an example embodiment, the determination may be based on received measurements of a communication network. The method may also include, at 205, predicting which case a mobile terminal needs to increase or reduce transmission power or perform a full transmission power. According to an example embodiment, the prediction may be performed based on the determination at 200.

The method may further include, at 210, configuring the mobile terminal with a predefined transmission power for one or more cases. For example, in an embodiment, configuring the predefined transmission power may include configuring a small value of predefined transmission power on a subband expected to have large interference. In another example embodiment, configuring the predefined transmission power may include configuring a large value of predefined transmission power on a specific set of non-orthogonal spreading code, if less frequent usage is expected for the case. The method may also include, at 215, configuring a set of modulation coding schemes from which the mobile terminal selects a modulation coding scheme for a radio transmission. In an example embodiment, configuring the set of modulation coding schemes may be based on the configuration of the mobile terminal at 210.

In an example embodiment, the predefined transmission power may be a maximum transmission power. In another example embodiment, the one or more cases may correspond to a configuration of UL transmission where separate settings are included for at least one of different physical resource blocks on a carrier, different carriers, different bandwidth parts, different targeted transmission reception points or panels at a mobile terminal side for transmission, different target block error rate, different criteria of modulation coding scheme levels to transmission power relation, different quality of service classes or traffic priority classes, or different configured grant transmission configurations or resources.

According to a further example embodiment, the configuration of the predefined transmission power may be for a group, and the group may include a plurality of mobile terminals and a plurality of multiple access signatures. In another example embodiment, the case may correspond to at least one or a combination of a specific carrier, a subband, a cell, a transmission reception point, a set of physical resource blocks, a non-orthogonal multiple access spreading code, or a target block error rate.

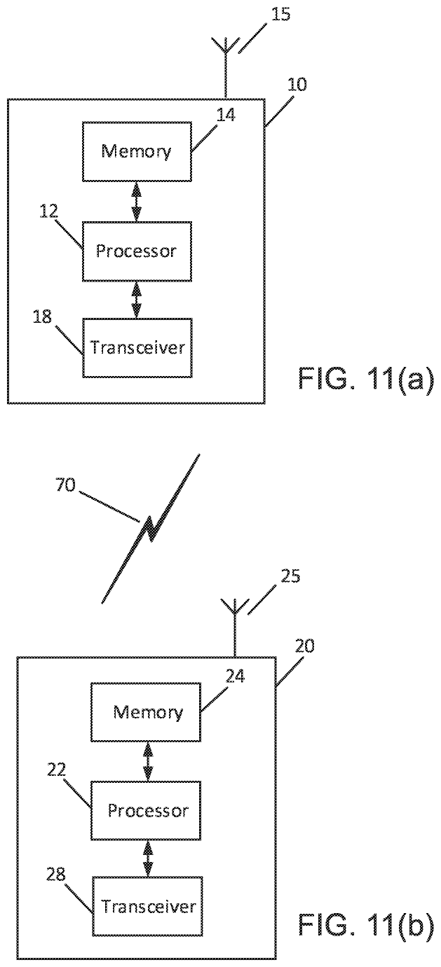

FIG. 11(a) illustrates an example of an apparatus 10 according to another example embodiment. In an embodiment, apparatus 10 may be a node or element in a communications network or associated with such a network, such as a UE, mobile equipment (ME), mobile station, mobile device, stationary device, IoT device, or other device. As described herein, UE may alternatively be referred to as, for example, a mobile station, mobile equipment, mobile unit, mobile device, user device, subscriber station, wireless terminal, tablet, smart phone, IoT device, sensor or NB-IoT device, or the like.

In some example embodiments, apparatus 10 may include one or more processors, one or more computer-readable storage medium (for example, memory, storage, or the like), one or more radio access components (for example, a modem, a transceiver, or the like), and/or a user interface. In some embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 11(a).

As illustrated in FIG. 11(a), apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 6a, multiple processors may be utilized according to other embodiments.

For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes illustrated in FIGS. 1-9.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods illustrated in FIGS. 1-9.

In some embodiments, apparatus 10 may also include or be coupled to one or more antennas 18 for receiving a downlink signal and for transmitting via an uplink from apparatus 10. Apparatus 10 may further include a transceiver 18 configured to transmit and receive information. The transceiver 28 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device). In certain embodiments, apparatus 10 may further include a user interface, such as a graphical user interface or touchscreen.

In an embodiment, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to an example embodiment, apparatus 10 may optionally be configured to communicate with apparatus 10 via a wireless or wired communications link 70 according to any radio access technology, such as NR.

According to certain example embodiments, processor 12 and memory 14 may be included in or may form a part of processing circuitry or control circuitry. In addition, in some embodiments, transceiver 28 may be included in or may form a part of transceiving circuitry.

As discussed above, according to certain example embodiments, apparatus 10 may be a UE, mobile device, mobile station, ME, IoT device and/or NB-IoT device, for example. According to certain embodiments, apparatus 10 may be controlled by memory 14 and processor 12 to perform the functions associated with example embodiments described herein. For example, in some embodiments, apparatus 10 may be configured to perform one or more of the processes depicted in any of the flow charts or signaling diagrams described herein, such as the flow diagrams illustrated in FIGS. 1-9.

For instance, in one embodiment, apparatus 10 may be controlled by memory 14 and processor 12 to receive a configuration of a predefined transmission power for one or more cases. The apparatus 10 may also be controlled by memory 14 and processor 12 to calculate a required transmission power based on at least a specific pathloss of the one or more cases. The apparatus 10 may further be controlled by memory 14 and processor 12 to select, based on the calculation of the required transmission power, a modulation coding scheme level that does not exceed the predefined transmission power for a radio transmission. In addition, the apparatus 10 may be controlled by memory 14 and processor 12 to perform the radio transmission based on the selected modulation coding scheme level and the calculated required transmission power.

FIG. 11(b) illustrates an example of an apparatus 20 according to an example embodiment. In an example embodiment, apparatus 20 may be a node, host, or server in a communication network or serving such a network. For example, apparatus 20 may be a satellite, base station, a Node B, an evolved Node B (eNB), 5G Node B or access point, next generation Node B (NG-NB or gNB), and/or WLAN access point, associated with a radio access network (RAN), such as an LTE network, 5G or NR. In certain example embodiments, apparatus 20 may be an eNB in LTE or gNB in 5G.

It should be understood that, in some example embodiments, apparatus 20 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 20 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 20 may include components or features not shown in FIG. 11(b).

As illustrated in the example of FIG. 11(b), apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 6b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes illustrated in FIGS. 1-8 and 10.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods illustrated in FIGS. 1-8 and 10.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 28 may be configured to modulate information on to a carrier waveform for transmission by the antenna(s) 25 and demodulate information received via the antenna(s) 25 for further processing by other elements of apparatus 20. In other embodiments, transceiver 18 may be capable of transmitting and receiving signals or data directly. Additionally or alternatively, in some embodiments, apparatus 20 may include an input and/or output device (I/O device).

In an embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some embodiments, processor 22 and memory 24 may be included in or may form a part of processing circuitry or control circuitry. In addition, in some embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 20 may be a network node or RAN node, such as a base station, access point, Node B, eNB, gNB, WLAN access point, or the like. According to certain embodiments, apparatus 10 may be controlled by memory 24 and processor 22 to perform the functions associated with any of the embodiments described herein, such as the flow or signaling diagrams illustrated in FIGS. 1-8 and 10.

For instance, in one embodiment, apparatus 20 may be controlled by memory 24 and processor 22 to determine, based on the received measurements of a communication network, which case out of a plurality of cases more interference would be detected. The apparatus 20 may also be controlled by memory 24 and processor 22 to predict, based on the determination, which case a mobile terminal needs to increase or reduce transmission power or perform a full power transmission. The apparatus 20 may further be controlled by memory 24 and processor 22 to, configure the mobile terminal with a predefined transmission power for one or more cases. Further, apparatus 20 may be controlled by memory 24 and processor 22 to configure, based on the configuration of the mobile terminal, a set of modulation coding schemes from which the mobile terminal selects a modulation coding scheme for a radio transmission. In an example embodiment, apparatus 20 may be controlled by memory 24 and processor 22 to configure a small value of predefined transmission power on a subband expected to have large interference. In another example embodiment, apparatus 20 may be controlled by memory 24 and processor 22 to configure a large value of predefined transmission power on a specific set of non-orthogonal spreading code, if less frequent usage is expected for the case.

Certain example embodiments described herein provide several technical improvements, enhancements, and/or advantages. According to certain example embodiments, it may be possible to reduce interference towards other nearby devices, base stations and cells, which may result in improvements in the signal quality observed by those nodes. According to other example embodiments, UE autonomous link adaptation/MCS selection may allow the UE to pick the best format for transmission, resulting in increased data rates for that UE. In other example embodiments, an scheme for gNB controlled UE's MCS/transmission power selection allowing for reliable and efficient (low interference) operation is provided. According to another example embodiment, it may be possible to provide a solution to improve the overall performance of unlicensed band communication by the procedures described herein including, for example, UE oriented MCS selection with gNB oriented interference management.

A computer program product may comprise one or more computer-executable components which, when the program is run, are configured to carry out some example embodiments. The one or more computer-executable components may be at least one software code or portions of it. Modifications and configurations required for implementing functionality of an example embodiment may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. Although the above embodiments refer to 5G NR and LTE technology, the above embodiments may also apply to any other present or future 3GPP technology, such as LTE-advanced, and/or fourth generation (4G) technology.

Partial Glossary

| | |
|---|---|
| BLER | Block Error Rate |
| BWP | Bandwidth Part |
| LAA | Licensed Assisted Access |
| LBT | Listen Before Talk |
| MCS | Modulation and Coding Scheme |
| NOMA | Non-Orthogonal Multiple Access |
| NR | New Radio |
| NR-U | New Radio-Unlicensed |
| P0 | Power Control Power Level 0 |
| PC | Power Control |
| PSD | Power Spectral Density |
| PUSCH | Physical Uplink Shared Channel |
| TB | Transport Block |
| TRP | Transmission Reception Point |
| UE | User Equipment |
| UL | Uplink |
| URLLC | Ultra-Reliable Low-Latency Communications |

1.-33. (canceled)

34. An apparatus, comprising: at least one processor; and at least one memory comprising computer program code, the at least one memory and the computer program code are configured, with the at least one processor to cause the apparatus at least to
receive a plurality of configured grant transmission configurations;
calculate for each of the plurality of configured grant transmission configurations, at least one required transmission power based on at least a pathloss specific to the respective configured grant transmission configuration;
select, based on the required transmission powers, a modulation and coding scheme level associated with a first of the required transmission powers calculated for a first of the plurality of configured grant transmission configurations that does not exceed a predefined transmission power for a radio transmission;
and perform the radio transmission based on the selected modulation and coding scheme level and the first of the required transmissions powers.

35. The apparatus according to claim 34, wherein the at least one memory and the computer program code are further configured, with the at least one processor to calculate the at least one required transmission power for each of the plurality of configured grant transmission configurations using a power offset specific to the respective configured grant transmission configuration.

36. The apparatus according to claim 34, wherein the selected modulation and coding scheme level is the highest possible modulation coding scheme level that the required transmission powers allow for.

37. The apparatus according to claim 34, wherein the at least one memory and the computer program code are configured to perform the radio transmission using the first of the plurality of configured grant transmission configurations.

38. The apparatus according to claim 34, wherein the plurality of configured grant transmission configurations comprise separate settings for at least one of different physical resource blocks on a carrier, different carriers, different bandwidth parts, different targeted transmission reception points or panels at a mobile terminal side for transmission, different target block error rate, different criteria of modulation coding scheme levels to transmission power relation, different quality of service classes or traffic priority classes.

39. The apparatus according to claim 34, wherein the at least one memory and the computer program code are further configured to select the modulation coding and scheme level dependent on a preference of transmission power or spectral efficiency.

40. The apparatus according to claim 34, wherein the predefined transmission power is for a group, wherein the group comprises a plurality of mobile terminals and a plurality of multiple access signatures.

41. The apparatus according to claim 34, wherein the at least one memory and the computer program code are further configured to calculate the at least one required transmission power is based on a service type specific radio operation.

42. A method, comprising:
receiving a plurality of configured grant transmission configurations;
calculating for each of the plurality of configured grant transmission configurations, at least one required transmission power based on at least a pathloss specific to the respective configured grant transmission configuration;
selecting, based on the required transmission powers, a modulation and coding scheme level associated with a first of the required transmission powers calculated for a first of the plurality of configured grant transmission configurations that does not exceed a predefined transmission power for a radio transmission;
and performing the radio transmission based on the selected modulation and coding scheme level and the first of the required transmissions powers.

43. The method according to claim 42, wherein the at least one required transmission power for each of the plurality of configured grant transmission configurations is calculated using a power offset specific to the respective configured grant transmission configuration.

44. The method according to claim 42, wherein the selected modulation and coding scheme level is the highest possible modulation coding scheme level that the required transmission powers allow for.

45. The method according to claim 42, wherein the performing the radio transmission comprises performing the radio transmission using the first of the plurality of configured grant transmission configurations.

46. The method according to claim 42, wherein the plurality of configured grant transmission configurations comprise separate settings for at least one of different physical resource blocks on a carrier, different carriers, different bandwidth parts, different targeted transmission reception points or panels at a mobile terminal side for transmission, different target block error rate, different criteria of modulation coding scheme levels to transmission power relation, different quality of service classes or traffic priority classes.

47. The method according to claim 42, wherein the selection of the modulation coding and scheme level is dependent on a preference of transmission power or spectral efficiency.

48. The method according to claim 42, wherein the predefined transmission power is for a group, wherein the group comprises a plurality of mobile terminals and a plurality of multiple access signatures.

49. The method according to claim 42, wherein calculating the at least one required transmission power is further based on a service type specific radio operation.

50. A computer program product comprising a non-transitory computer readable storage medium storing executable code that, when executed by at least one data processing apparatus is configured to cause the at least one data processing apparatus to:
receive a plurality of configured grant transmission configurations;
calculate for each of the plurality of configured grant transmission configurations, at least one required transmission power based on at least a pathloss specific to the respective configured grant transmission configuration;
select, based on the required transmission powers, a modulation and coding scheme level associated with a first of the required transmission powers calculated for a first of the plurality of configured grant transmission configurations that does not exceed a predefined transmission power for a radio transmission;
and perform the radio transmission based on the selected modulation and coding scheme level and the first of the required transmissions powers
